(19) United States
(12) Patent Application Publication
(10) Pub. No.: US 2026/0245474 A1
(43) Pub. Date: Aug. 20, 2026

(54) Remote Educational Learning System

(71) Applicant: Adam Denoto, Brook Park, OH (US)

(72) Inventor: Adam Denoto, Brook Park, OH (US)

(21) Appl. No.: 19/335,091

(22) Filed: Sep. 22, 2025

Related U.S. Application Data
(60) Provisional application No. 63/759,579, filed on Feb. 18, 2025.

(51) Int. Cl. G09B 7/04; G06Q 40/06; G06Q 50/20

(52) U.S. Cl. CPC G09B 7/04; G06Q 40/06; G06Q 50/2053

(57) ABSTRACT

An artificial intelligence–based educational learning system is disclosed. The system includes a software application executing on a user device that provides graphical interfaces for lesson plans, assignments, financial literacy exercises, and interactive sessions with an AI-generated avatar teacher. A server system communicates with the user device via a network and comprises a plurality of modules, including an AI-powered learning engine configured to analyze student interactions and generate personalized lesson plans, a curriculum and content management system for storing academic and financial literacy content, and a financial investment module for allocating tuition funds into diversified financial instruments and tracking fund performance. The system further includes an avatar module for delivering adaptive, real-time instruction and a parental control module for monitoring student progress. The system provides student enrollment, tuition-based investments, adaptive lesson generation, and the creation of a dual academic and financial report card.

### CROSS-REFERENCE TO RELATED APPLICATION

The present application claims priority to, and the benefit of, U.S. Provisional Application No. 63/759,579 which was filed on Feb. 18, 2025, and is incorporated herein by reference in its entirety.

### FIELD OF THE INVENTION

The present invention generally relates to educational platforms that combine artificial intelligence and homeschooling methodologies. More specifically, the present invention relates to an AI-powered remote educational learning system configured to deliver a merit-based K–12 curriculum with integrated financial literacy training and tuition-based investment management. The invention comprises a user device, such as a computer, tablet, or smartphone, executing a software application that communicates with a server system through a network. The server system includes an AI-powered learning engine for generating personalized lesson plans, a curriculum and content management system for storing academic and financial education materials, a financial investment module for allocating tuition funds into diversified financial instruments, and an avatar module for providing real-time AI-generated virtual teachers. Students access assignments, lessons, and financial exercises through graphical interfaces, while parents monitor progress through a parental control module. Accordingly, the present disclosure makes specific reference thereto. Nonetheless, it is to be appreciated that aspects of the present invention are also equally applicable to other like applications, devices, and methods of manufacture.

### BACKGROUND

By way of background, individuals require financial literacy, wealth management, and related skills for long-term personal and professional success. However, such subjects are often not adequately taught in traditional educational environments, including public schools, charter schools, and private institutions. Existing educational systems typically emphasize core academic subjects such as mathematics, science, and language arts while neglecting practical instruction in financial independence, credit building, investment strategies, and fiscal responsibility. As a result, children and young adults frequently enter adulthood without the foundational knowledge required to make informed financial decisions.

Moreover, public school environments may present challenges including overcrowded classrooms, safety concerns, and inconsistent teaching quality, which can negatively affect student performance and overall well-being. For some families, homeschooling has emerged as a viable alternative that offers personalized instruction and a safer learning environment. However, conventional homeschooling programs often lack structured tools and resources for delivering comprehensive financial education alongside standard academic subjects. Accordingly, individuals desire an improved educational system that integrates traditional K–12 curricula with financial literacy training and wealth management education.

Therefore, there exists a long-felt need in the art for an educational system that integrates financial literacy and wealth management into structured K–12 curricula. There is a need for a homeschooling platform that combines standard academic instruction with personalized financial education in a safe, adaptable, and merit-based environment. Further, there is a need in the art for a system that reinvests tuition funds into diversified financial assets, such as cryptocurrency baskets, index funds, and bullion, to provide students with direct exposure to real-world financial principles. Additionally, there is a need for a system that delivers adaptive, AI-driven instruction through virtual avatars. Moreover, there is a long-felt need in the art for an education system that utilizes artificial intelligence to communicate with the students and tailors the program to their needs based on their current education. Finally, there exists a need for a home education platform that empowers families with oversight tools, ensures long-term financial literacy, and enhances student independence and success.

The subject matter disclosed and claimed herein, in one embodiment, comprises an artificial intelligence–powered remote educational learning system configured to provide both academic instruction and financial literacy training. The system includes a software application executed on a user device such as a computer, tablet, or smartphone, in communication with a server system via a network. The server system comprises an AI-powered learning engine for generating personalized lesson plans, a curriculum and content management system for storing and updating educational materials, a financial investment module for managing tuition-based investments, an avatar module for generating AI-driven teachers, and a parental control module for oversight and reporting. Tuition funds paid into the system are automatically allocated into one or more financial instruments, and the performance of such investments is incorporated into the student’s monthly financial report card, alongside traditional academic evaluations.

In one embodiment, the AI-powered learning engine analyzes student responses to assignments, quizzes, and exercises, and dynamically adjusts lesson difficulty, sequencing, and instructional style. In another embodiment, the avatar module generates customizable AI teachers in two-dimensional, three-dimensional, or video-synthesized forms, each capable of real-time conversational interaction through natural language processing. In yet another embodiment, the financial investment module employs artificial intelligence trading algorithms to execute trades across cryptocurrency markets and traditional securities, thereby aligning financial literacy lessons with actual portfolio performance.

In this manner, the AI-powered remote educational learning system of the present invention addresses longstanding shortcomings of traditional education by unifying academics, financial literacy, and wealth management into a single homeschooling platform. The invention provides personalized, adaptive instruction delivered through AI avatars, while simultaneously teaching about investments. The system offers a reliable, secure, and engaging platform that prepares students for both academic success and lifelong financial independence, thereby enhancing the functionality, usability, and societal value of homeschooling solutions.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an artificial intelligence–based educational learning system. The system comprises a user device executing a software application that is configured to provide one or more graphical interfaces for accessing lesson plans, assignments, financial literacy exercises, and interactive sessions with an avatar teacher. The system further comprises a server system in communication with the user device via a network. The server system includes an AI-powered learning engine configured to analyze student interactions and generate personalized lesson plans based on performance data, a curriculum and content management system configured to store and deliver academic subjects and financial literacy materials, and a financial investment module configured to allocate tuition funds into one or more financial instruments and track performance of the allocated funds. The server system further comprises an avatar module configured to generate an AI-based avatar teacher for providing real-time instructional content and a parental control module configured to provide oversight of academic progress and financial literacy results.

In another embodiment, a method for delivering an AI-powered home educational experience is described and comprises the steps of enrolling a student into a software application executed on a user device, receiving tuition funds from a parent or guardian and directing the funds into a financial investment module, and allocating the tuition funds across a plurality of asset classes including at least one of cryptocurrency, index funds, and bullion. The method further comprises tracking performance of the allocated funds and generating financial literacy data, analyzing student performance in academic and financial exercises using an AI-powered learning engine, and generating a personalized lesson plan and a consolidated financial report card based on the student performance and the tracked fund performance.

In one embodiment, the software application provides a user interface that includes an assignment area configured to display interactive academic or financial literacy exercises, an avatar display area configured to present a virtual AI teacher for delivering instruction, and a lesson information and control area configured to provide navigation tools, instructional details, and parental access. The avatar display area and the assignment area are operatively linked such that the avatar dynamically adjusts instructional delivery in response to student inputs provided in the assignment area.

In yet another embodiment, the system includes an avatar module which is configured to generate at least one of a two-dimensional character, a three-dimensional character, a voice-based digital assistant, or a video-synthesized human representation. The avatar enables conversational interaction with a student through speech or text.

In still another embodiment, the system comprises a security engine configured to provide end-to-end encryption, secure authentication protocols, and role-based access controls to protect student performance data, parental monitoring data, and investment records from unauthorized access.

In one embodiment, the avatar is further configured to provide bilingual or multilingual instruction and dynamically switch between languages in response to the curriculum requirements or student preference, thereby enhancing accessibility and inclusivity of the educational platform.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a system architecture block diagram of artificial intelligence–based educational learning system of the present invention in accordance with the disclosed structure;

FIG. 2 illustrates a flow diagram depicting a method for initiating and operating the artificial intelligence–based remote educational learning system of the present invention in accordance with the disclosed architecture;

FIG. 3 illustrates a flow diagram depicting steps for conducting an interactive learning session within the artificial intelligence–based home educational system of the present invention in accordance with the disclosed architecture;

FIG. 4 illustrates a flow diagram of an exemplary method for processing tuition funds and managing financial investments of students in the artificial intelligence–based remote educational learning system of the present invention;

FIG. 5 illustrates a flow diagram depicting exemplary steps for personalizing education through student performance analysis within the artificial intelligence–based remote educational learning system of the present invention in accordance with the disclosed structure;

FIG. 6 illustrates a flow diagram of an exemplary method for generating and publishing financial report cards (i.e., financial dashboard) in the artificial intelligence–based remote educational learning platform of the present invention;

FIG. 7 illustrates an exemplary template of user interface of the artificial intelligence–based remote educational learning system as displayed on a user device by the software application in accordance with the disclosed architecture; and

FIG. 8 illustrates an exemplary tablet-based interface of the artificial intelligence–based remote educational learning system of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an educational system that integrates financial literacy and wealth management into structured K–12 curricula. There is a need for a homeschooling platform that combines standard academic instruction with personalized financial education in a safe, adaptable, and merit-based environment. Further, there is a need in the art for a system that reinvests tuition funds into diversified financial assets, such as cryptocurrency baskets, index funds, and bullion, to provide students with direct exposure to real-world financial principles. Additionally, there is a need for a system that delivers adaptive, AI-driven instruction through virtual avatars. Moreover, there is a long-felt need in the art for an education system that utilizes artificial intelligence to communicate with the students and tailors the program to their needs based on their current education. Finally, there exists a need for a home education platform that empowers families with oversight tools, ensures long-term financial literacy, and enhances student independence and success.

The present invention, in one exemplary embodiment, is a method for delivering an AI-powered home educational experience and comprises the steps of enrolling a student into a software application executed on a user device, receiving tuition funds from a parent or guardian, directing the funds into a financial investment module, and allocating the tuition funds across a plurality of asset classes including at least one of cryptocurrency, index funds, and bullion. The method further comprises tracking performance of the allocated funds and generating financial literacy data, analyzing student performance in academic and financial exercises using an AI-powered learning engine, and generating a personalized lesson plan and a consolidated financial report card based on the student performance and the tracked fund performance.

The present invention discloses an artificial intelligence–based remote educational learning system designed to deliver a comprehensive K–12 homeschooling experience while simultaneously fostering financial literacy and wealth management skills. The invention provides several advantages over conventional educational methods by integrating financial investment management directly into the tuition model. The system teaches students fiscal responsibility through exposure to real-world financial performance, thereby addressing a critical gap in traditional educational system.

Reference will now be made in detail to the present preferred embodiments of the invention, examples of which are illustrated in the accompanying drawings. Wherever possible, the same reference numerals are used in the drawings and the description to refer to the same or like parts.

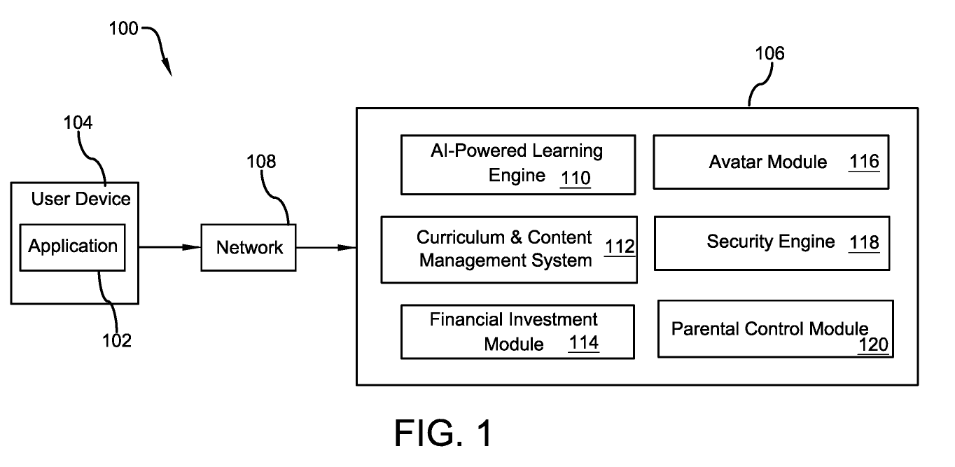

Referring initially to the drawings, FIG. 1 illustrates a system architecture block diagram of artificial intelligence–based educational learning system of the present invention in accordance with the disclosed structure. The artificial intelligence (AI)–based remote educational learning system 100 of the present invention is an AI-powered educational system designed to deliver a merit-based K–12 educational experience with a focus on financial literacy and fiscal stability. The system 100 combines traditional academic subjects (i.e., math and English) with financial education, wherein tuition funds can be reinvested into financial assets for students. The system 100 includes a software application 102 installed in a user device 104 such as a desktop computer, laptop, tablet, smartphone, or any other similar electronic computing device. The application 102 is executed on the user device 104 and is configured to provide a plurality of graphical interfaces through which students access lesson plans, assignments, financial literacy exercises, and interactive sessions with AI avatar teachers as described later in the disclosure.

The application 102 is configured to be coupled with a server system 106 via a network 108. The network 108 facilitates communication (i.e., provides communication link) between the user device 104 and the server system 106. Further, the network 108 may include the Internet, local area networks, wireless connections, or cloud infrastructure. The server system 106 includes a plurality of modules, wherein each module is configured to execute a specific role in delivering adaptive education and financial literacy training.

An AI-powered learning engine 110 is configured to deliver personalized and adaptive educational experiences by employing artificial intelligence (AI) and machine learning algorithms. The AI-powered learning engine 110 is configured to analyze student interactions, including responses to assignments, quiz performance, behavioral patterns, and learning pace, to dynamically adjust the complexity, sequence, and style of instructional content. In one embodiment, the AI-powered learning engine 110 incorporates natural language processing (NLP) models to enable conversational interaction with students through text, audio, or video-based avatars, thereby simulating the presence of a human teacher. The AI-powered learning engine 110 further generates individualized lesson plans by cross-referencing the student’s historical performance data, mastery of prior topics, and designated learning objectives.

The curriculum and content management system 112 stores a repository of instructional materials, including both traditional K–12 academic subjects such as mathematics, science, and language arts, and financial literacy curriculum such as personal budgeting, stock market trading, and credit-building exercises. The curriculum and content management system 112 is adapted to organize lesson plans, assignments, quizzes, and interactive media, while enabling dynamic updates to reflect current educational standards and financial market conditions. In the preferred embodiment, the curriculum and content management system 112 is in logical communication with the AI-powered learning engine 110 to deliver content at a difficulty level appropriate to the assessed proficiency of students.

The financial investment module 114 is configured to manage tuition funds contributed by parents or guardians (i.e., others). The financial investment module 114 allocates the funds into a plurality of financial instruments including but not limited to cryptocurrency baskets, S&P 500 index funds, and physical silver bullion, thereby diversifying investment strategies across digital, equity, and tangible assets. The financial investment module 114 may employ artificial intelligence trading algorithms for executing 24/7 cryptocurrency trades for optimizing portfolio growth.

The investment results from the investments are aggregated and compiled into a monthly financial report card for each student, which is provided to both the student and parent. The financial investment module 114 further integrates with the AI-powered learning engine 110 to generate simulations and exercises derived from the actual investment portfolio performance of the student.

The avatar module 116 is configured to provide AI-generated virtual teachers or avatars for teaching students. It should be noted that the system 100 uses AI-generated virtual teachers which are capable of real-time conversational interaction powered by natural language processing (NLP) and text-to-speech/speech-to-text technologies. The avatars provided by the avatar module 116 can be customizable in terms of appearance, voice, and teaching style, thereby offering students a personalized and engaging learning environment. For each subject and level, there can be one or more unique avatars for teaching students.

The avatar provided by the avatar module 116 can be a two-dimensional (2D) or three-dimensional (3D) graphical character, a voice-based digital assistant, or a video-synthesized human representation generated using deep learning models such as generative adversarial networks (GANs) or text-to-avatar rendering engines.

The avatar module 116 interacts with the AI-powered learning engine 110 to deliver instructional content, respond to student queries, and provide guidance in an intuitive and human-like manner. Additionally, the avatar may facilitate gamification by incorporating motivational feedback, badges, or encouragement, thereby improving student engagement and retention. The avatar may adjust its behavior, tone, and instructional delivery style based on the current performance metrics and emotional state of a student. As a non-limiting example, the avatar may slow down explanations, repeat instructions, or shift to a different teaching method, for example from visual demonstration to verbal explanation if the student is struggling with a particular concept.

In some embodiments, the avatar module 116 may operate in part on the user device 104 to enable smooth rendering and real-time responsiveness, while computationally intensive processes such as 3D rendering may be handled by the server system 106.

The avatar may support bilingual or multilingual instruction and can dynamically switch between languages as required by the curriculum or student preference. The avatar module 116 may also provide accessibility features such as closed captioning, sign-language animations, or simplified speech modes, for inclusivity of students with different learning needs.

The security engine 118 provides end-to-end encryption, secure authentication protocols, and role-based access controls to protect student performance data, parental monitoring data, and investment records from unauthorized access. The security engine 118 is also configured to generate alerts for system administrators or parents when unauthorized access attempts, data breaches, or abnormal activity patterns are detected. The security engine 118 also verifies the accuracy of financial reporting and educational content delivery.

A parental control module 120 provides real-time oversight of both academic progress and financial literacy development of the students to parents or guardians (i.e., others). The parental control module 120 is configured to generate one or more dashboards accessible through the user application 102, wherein the dashboards may display lesson completion rates, quiz performance, and skill mastery, alongside investment summaries and portfolio growth metrics. The module 120 enables parents to set usage restrictions, time limits, or content access filters on the content displayed to the students, enabling the students to engage with the content in an age-appropriate and balanced learning experience.

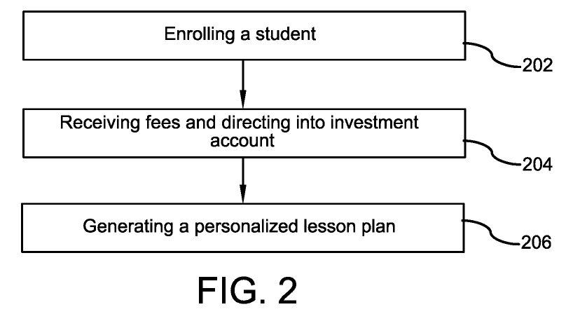

FIG. 2 illustrates a flow diagram depicting a method for initiating and operating the artificial intelligence–based remote educational learning system of the present invention in accordance with the disclosed architecture. Initially, a student is enrolled into the system 100 using the software application 102 (Step 202). The enrollment of the student may include creating a student profile which may include demographic and educational background information. The student profile is associated with a parental control account and a tuition funds account.

Then, the system 100 receives tuition funds from the parent or guardian of the student and automatically directs such funds into a designated investment account of the student (Step 204). In one embodiment, the investment account is managed by the financial investment module 114 of FIG. 1, which may allocate the funds across diversified asset classes including but not limited to cryptocurrency baskets, S&P 500 index funds, and physical silver bullion. The reinvestment process of the system 100 enables the tuition funds to serve as both an educational subscription and a financial literacy teaching tool for the students.

Finally, the AI-powered learning engine 110 and the curriculum and content management system 112, generate a personalized lesson plan tailored to the current academic standing, performance metrics, and financial education requirements of the student (Step 206). The lesson plan may include traditional academic subjects such as mathematics or science, as well as financial literacy modules aligned with the investment portfolio and financial goals of the student.

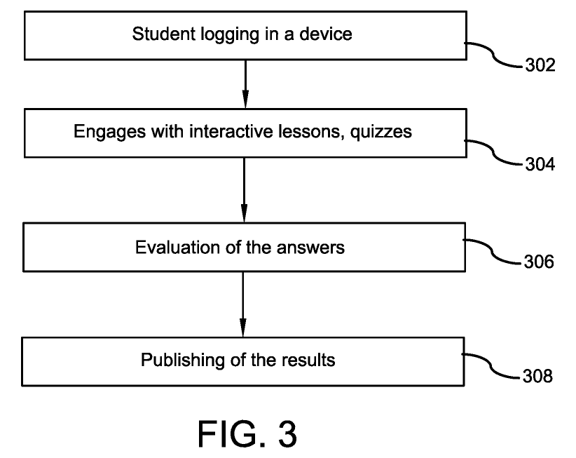

FIG. 3 illustrates a flow diagram depicting steps for conducting an interactive learning session within the artificial intelligence–based home educational system of the present invention in accordance with the disclosed architecture. Initially, a student logs into the system 100 using the software application 102 on the user device 104 (Step 302). The login process may include authentication credentials and association with the personalized profile of the student.

Then, the student can engage with interactive lessons and quizzes delivered by the system 100 on the software application 102 (Step 304). The lessons may include standard academic exercises, financial literacy training, or simulations of investment decision-making, all presented through the avatar for improved engagement. As described in FIG. 1, an avatar teaches the student and based on the preferences of the student, the avatar can be customized for an improved learning environment for the student.

Thereafter, responses of the students are evaluated using artificial intelligence algorithms by the AI-powered learning engine 110 to determine accuracy, comprehension, and proficiency (Step 306). The evaluation may include automated grading and deeper semantic analysis for responses. In certain embodiments, the AI-powered learning engine 110 further adapts lesson difficulty in real time based on evaluation outcomes.

Finally, the system 100 publishes the results for the students and the results are available on both the dashboard of the students and the parental control module 120 (Step 308). The results may be displayed as performance reports, progress indicators, or financial literacy achievements, and may also be aggregated into the student’s monthly academic and financial report card.

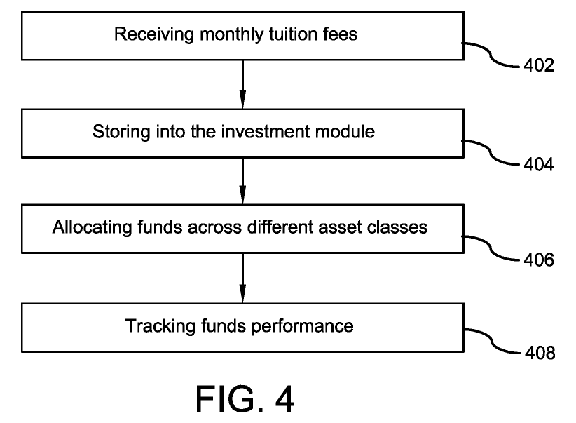

FIG. 4 illustrates a flow diagram of an exemplary method for processing tuition funds and managing financial investments of students in the artificial intelligence–based remote educational learning system of the present invention. Initially, the system 100 receives monthly tuition funds of a student, or on behalf of a student, through a user device interface or an associated payment gateway provided by the application 102 (Step 402). Then, the tuition funds are stored into the financial investment module 114 of FIG. 1 (Step 404). The financial investment module 114 securely records and manages the funds and prepares the funds for allocation in various financial instruments.

The funds are then allocated across different asset classes, which may include cryptocurrency baskets, S&P 500 index funds, and physical silver bullion (Step 406). The allocation strategy may be determined by predefined rules, parental preferences, or an artificial intelligence trading algorithm designed to balance growth potential with risk management.

Finally, the system 100 tracks the performance of the allocated funds for monitoring (Step 408). In one embodiment, performance tracking occurs in real time for cryptocurrency assets and periodically for traditional investments such as index funds or bullion. The tracked performance data may be used both for generating a monthly financial report card for the student and for tailoring financial literacy exercises within the educational platform.

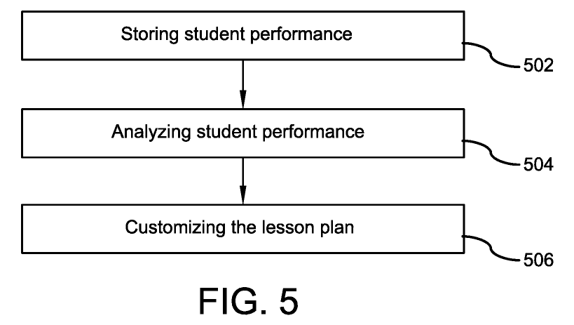

FIG. 5 illustrates a flow diagram depicting exemplary steps for personalizing education through student performance analysis within the artificial intelligence–based remote educational learning system of the present invention in accordance with the disclosed structure. The system 100 stores student performance data collected during interactive lessons, quizzes, and financial literacy exercises (Step 502). The data may include correct and incorrect responses, completion times, engagement levels, progress history, and more.

Then, the stored student performance data is analyzed by the AI-powered learning engine 110 of FIG. 1 (Step 504). The analysis may utilize artificial intelligence algorithms, predictive analytics, and machine learning models to identify trends, strengths, weaknesses, and potential knowledge gaps for the student.

Finally, the system 100 customizes the lesson plan for the student based on the analyzed performance data (Step 506). Customization may include adjusting the difficulty level of future lessons, altering the sequencing of topics, recommending remedial modules, or introducing accelerated materials for advanced learners. In some embodiments, the customized lesson plan may also incorporate financial literacy exercises tied to the investment report of the student, thereby creating an integrated academic and financial learning path.

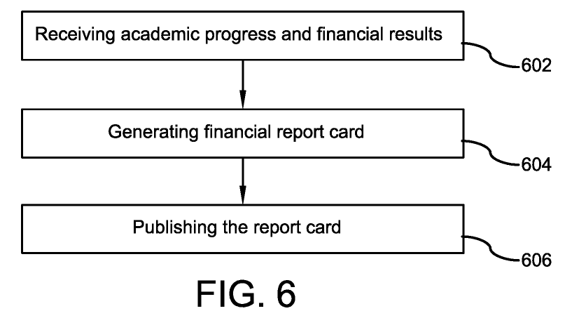

FIG. 6 illustrates a flow diagram of an exemplary method for generating and publishing financial report cards (i.e., financial dashboard) in the artificial intelligence–based remote educational learning platform of the present invention. Initially, the academic progress of student and the financial results of the investments of the student are received and stored in the AI-powered learning engine 110 (Step 602).

Then, the system generates a financial report card for the student by consolidating both the academic performance metrics and the financial portfolio results (Step 604). In one embodiment, the report card may include subject-wise academic scores, progress charts, and investment returns from asset classes such as cryptocurrencies, index funds, and bullion. The financial report card integrates educational achievement with financial literacy outcomes, providing a dual-progress measurement tool.

Thereafter, a report card is published and made accessible through to the student and parent (Step 606). The published report card may be displayed on the user device 104, transmitted to the parental control module 120, or delivered via secure communication channels such as email or cloud storage. In certain embodiments, the published report card may also include badges, milestones, or rankings to increase student motivation.

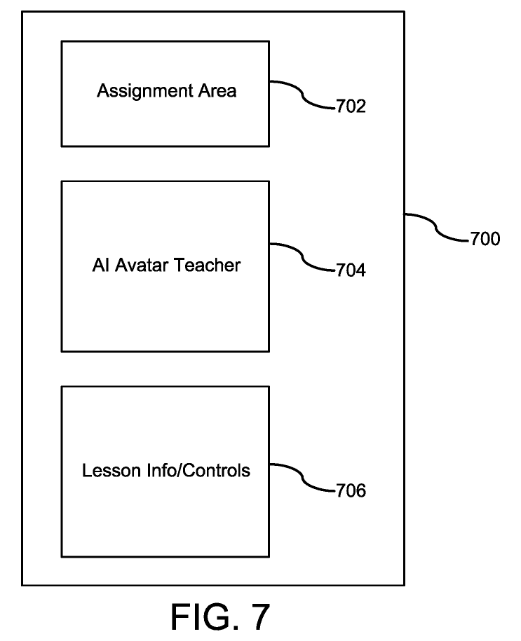

FIG. 7 illustrates an exemplary template of user interface of the artificial intelligence–based remote educational learning system as displayed on a user device by the software application in accordance with the disclosed architecture. The user interface 700 may comprise a plurality of sections to enable students to interact with assignments, receive instruction from an AI avatar, and manage lesson information. As illustrated, an assignment area 702 is configured to display academic or financial literacy exercises assigned to a student. The assignment area 702 may include, for example, handwriting practice charts, mathematics problems, reading comprehension passages, or financial simulations such as budgeting or trading tasks. In some embodiments, the assignment area 702 is interactive, enabling the student to input responses directly into the interface using a touchscreen, keyboard, or stylus.

An AI avatar teacher 704 section functions as the interactive instructional component of the interface 700. The AI avatar teacher 704 is generated by the avatar module 116 of FIG. 1 and is configured to deliver real-time guidance, explanations, and motivational feedback to the student. The avatar may appear in the form of a visual character or voice-based entity and is capable of adapting its teaching style based on the student’s responses and performance.

A lesson information section 706 provides supporting instructional details, navigation tools, and user controls. The section 706 may display text-based explanations, lessons, hints, or additional resources, while also enabling students to pause, replay, or skip sections of the lesson.

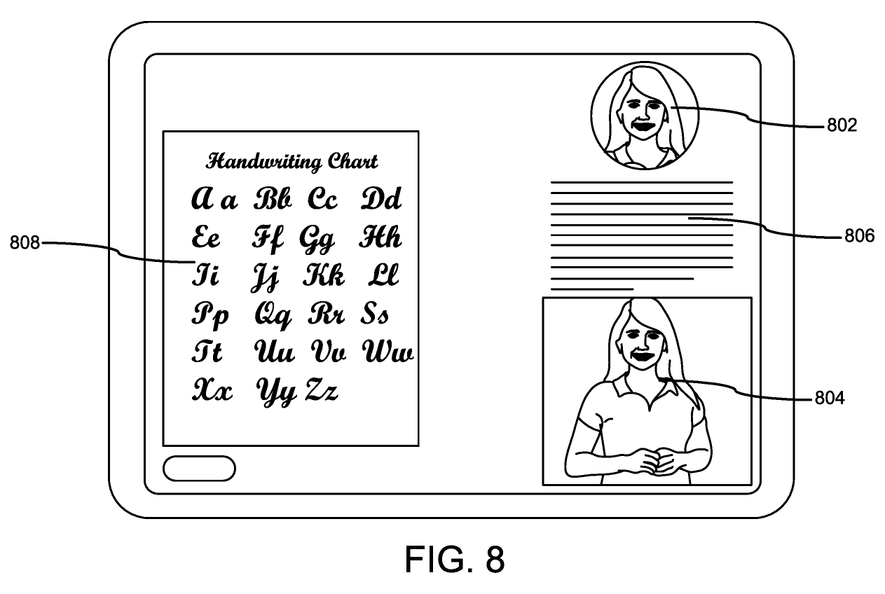

FIG. 8 illustrates an exemplary tablet-based interface of the artificial intelligence–based remote educational learning system of the present invention in accordance with the disclosed architecture. The interface includes an avatar display area 802, which displays a portrait view of the AI avatar teacher generated by the avatar module 116 of FIG. 1. A live instructional display area 804 includes the AI avatar teacher in an active teaching mode. The live instructional display 804 may show the avatar in video or animated form, synchronized with lesson narration or feedback to the student.

The interface also displays an explanation area 806, which contains supporting written content, such as instructional notes, guidelines, or explanations related to the current lesson. The text area 806 supplements the spoken or visual instructions provided by the avatar, creating a multimodal teaching environment. A lesson and assignment area 808 is configured to present student lessons and exercises in subjects such as handwriting, mathematics, or financial literacy. Students may directly interact with the section 808 by inputting answers, tracing characters, or completing digital worksheets.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “AI-powered remote educational learning system”, “artificial intelligence–based remote educational learning system”, “AI-based learning system”, and “system” are interchangeable and refer to the AI–based remote educational learning system 100 of the present invention.

Notwithstanding the forgoing, the AI–based remote educational learning system 100 of the present invention can be of any suitable configuration as is known in the art without affecting the overall concept of the invention, provided that it accomplishes the above stated objectives. One of ordinary skill in the art will appreciate that the AI–based remote educational learning system 100 shown in the FIGS. are for illustrative purposes only, and that many other configurations of the AI–based remote educational learning system 100 are well within the scope of the present disclosure. Although the dimensions of the AI–based remote educational learning system 100 are important design parameters for user convenience, the AI–based remote educational learning system 100 may be of any size that ensures optimal performance during use and/or that suits the user’s needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A remote-based educational learning system comprising:
a student;
a user device;
a software application;
a server system;
a network;
an AI-powered learning engine; and
a repository of instructional material;
wherein said user device selected from the group consisting of a desktop computer, a laptop, a tablet, and a smartphone;
wherein said software application configured to provide a plurality of graphical interfaces on said user device for said student to access material selected from the group consisting of lesson plans, assignments, financial literacy exercises, and interactive sessions;
wherein said network links said user device and said server system;
wherein said network selected from the group consisting of an Internet, a local area network, a wireless connection, and a cloud infrastructure;
wherein said AI-powered learning engine is configured to deliver adaptive educational experiences by employing artificial intelligence (AI) and machine learning algorithms based on analysis of said student’s interactions selected from the group consisting of responses to assignments, quiz performances, behavioral patterns, and learning pace;
wherein said adaptive educational experiences include adaptations of complexity, sequence, and instructional content;
wherein said repository of instructional material selected from the group consisting of mathematics, science, language arts, and financial literacy curriculum; and
further wherein said financial literacy curriculum selected from the group consisting of personal budgeting, stock market trading, and credit-building exercises.

2. The remote-based educational learning system of claim 1 further comprising a financial investment module configured to receive tuition funds contributed by others, wherein said financial investment module allocates said tuition funds into a plurality of financial instruments selected from the group consisting of cryptocurrency, S&P 500 index funds, and silver bullion.

3. The remote-based educational learning system of claim 2, wherein said financial investment module comprising simulations of investments of said tuition funds for developing investment portfolio performance of said student.

4. The remote-based educational learning system of claim 3 further comprising an avatar module configured to provide an avatar virtual teacher for teaching said student, wherein said avatar virtual teacher comprising customizable features selected from the group consisting of appearance, voice, and teaching style.

5. The remote-based educational learning system of claim 4, wherein said avatar module interacts with said AI-powered learning engine to deliver said instructional content, respond to student queries, provide guidance in a human-like manner, and adjust instructional delivery based on performance of said student.

6. The remote-based educational learning system of claim 5, wherein said avatar module providing content selected from the group consisting of motivational feedback and badges.

7. The remote-based educational learning system of claim 6 further comprising a control module comprising a real-time oversight of academic progress and financial literacy development of said student by said others, and further wherein said control module generates a dashboard of information selected from the group consisting of lesson completion rates, quiz performances, investment summaries, and portfolio growth metrics.

8. The remote-based educational learning system of claim 7, wherein said tuition funds are reinvested into financial assets for said student.

9. A method of remote financial literacy learning, the method comprising the steps of:
providing a student, an electronic user device, a software application, a server system, a network, an AI-powered learning engine, and a repository of instructional material;
providing a plurality of graphical interfaces on said electronic user device with said software application for said student to access material selected from the group consisting of lesson plans, assignments, financial literacy exercises, and interactive sessions;
linking said electronic user device and said server system with said network, wherein said network selected from the group consisting of an Internet, a local area network, a wireless connection, and a cloud infrastructure;
employing said AI-powered learning engine and machine learning algorithms to deliver adaptive educational experiences based on analysis of said student’s interactions selected from the group consisting of responses to assignments, quiz performances, behavioral patterns, and learning pace;
adapting complexity, sequence, and instructional content of said adaptive educational experiences;
wherein said repository of instructional material selected from the group consisting of mathematics, science, language arts, and financial literacy curriculum;
wherein said financial literacy curriculum selected from the group consisting of personal budgeting, stock market trading, and credit-building exercises;
receiving tuition funds;
directing said tuition funds into an investment account of said student; and
allocating said tuition funds across diversified asset classes selected from the group consisting of cryptocurrency, S&P 500 index funds, and silver bullion.

10. The method of remote financial literacy learning of claim 9 further comprising a step of providing a financial investment module, wherein said financial investment module comprises simulations of investments of said tuition funds for developing investment portfolio performance of said student.

11. The method of remote financial literacy learning of claim 9 further comprising a step of providing an avatar module configured to provide an avatar virtual teacher for teaching said student, wherein said avatar virtual teacher comprising customizable features selected from the group consisting of appearance, voice, and teaching style.

12. The method of remote financial literacy learning of claim 11, wherein said avatar module interacts with said AI-powered learning engine to deliver said instructional content, respond to student queries, provide guidance in a human-like manner, and adjust instructional delivery based on performance of said student.

13. The method of remote financial literacy learning of claim 12, wherein said avatar module providing content selected from the group consisting of motivational feedback and badges.

14. The method of remote financial literacy learning of claim 13 further comprising a step of providing a control module comprising a real-time oversight of academic progress and financial literacy development of said student by said others, wherein said control module generates a dashboard of information selected from the group consisting of lesson completion rates, quiz performances, investment summaries, and portfolio growth metrics.

15. The method of remote financial literacy learning of claim 14, wherein said tuition funds are reinvested into financial assets for said student.

16. A method of remote financial literacy learning, the method comprising the steps of:
providing a student, an electronic user device, a software application, a server system, a network, an AI-powered learning engine, and a repository of instructional material;
providing a plurality of graphical interfaces on said electronic user device with said software application for said student to access material selected from the group consisting of lesson plans, assignments, financial literacy exercises, and interactive sessions;
linking said electronic user device and said server system with said network, wherein said network selected from the group consisting of an Internet, a local area network, a wireless connection, and a cloud infrastructure;
employing said AI-powered learning engine and machine learning algorithms to deliver adaptive educational experiences based on analysis of said student’s interactions selected from the group consisting of responses to assignments, quiz performances, behavioral patterns, and learning pace;
wherein said repository of instructional material selected from the group consisting of mathematics, science, language arts, and financial literacy curriculum;
wherein said financial literacy curriculum selected from the group consisting of personal budgeting, stock market trading, and credit-building exercises;
receiving tuition funds;
directing said tuition funds into an investment account of said student; and
customizing said adaptive educational experiences selected from the group consisting of adjusting the difficulty level of future lessons, altering the sequencing of topics, recommending remedial modules, and introducing accelerated materials for advanced learners.

17. The method of remote financial literacy learning of claim 16 further comprising a step of allocating said tuition funds across diversified asset classes selected from the group consisting of cryptocurrency, S&P 500 index funds, and silver bullion.

18. The method of remote financial literacy learning of claim 16 further comprising a step of providing a financial investment module, wherein said financial investment module comprising simulations of investments of said tuition funds for developing investment portfolio performance of said student.

19. The method of remote financial literacy learning of claim 16 further comprising a step of providing an avatar module configured to provide an avatar virtual teacher for teaching said student, wherein said avatar virtual teacher comprising customizable features selected from the group consisting of appearance, voice, and teaching style.

20. The method of remote financial literacy learning of claim 19, wherein said avatar module interacts with said AI-powered learning engine to deliver said instructional content, respond to student queries, provide guidance in a human-like manner, and adjust instructional delivery based on performance of said student.
